(19) United States
(12) Patent Application Publication
(10) Pub. No.: US 2021/0094242 A1
(43) Pub. Date: Apr. 1, 2021

(54) RESIN MOLDED ARTICLE

(71) Applicant: MORIROKU TECHNOLOGY COMPANY, LTD., Tokyo (JP)

(72) Inventors: Nobuya Egashira, Tokyo (JP); Daisuke Saitama, Tokyo (JP)

(21) Appl. No.: 17/030,876

(22) Filed: Sep. 24, 2020

(30) Foreign Application Priority Data
Sep. 27, 2019 (JP) 2019-177531
Jul. 9, 2020 (JP) 2020-118182

(51) Int. Cl. B29C 65/00

(52) U.S. Cl. CPC B29C 66/72

(57) ABSTRACT

A resin molded article includes a main body or a plate portion formed in a substantially rectangular plate shape, and at least one rib that is integrally raised from the plate portion. The plate portion has a pair of long sides facing each of her, and a pair of short sides facing each other. The short sides are shorter than the long sides. Each of at least one rib is formed along at least one of the two long sides such that the rib includes, at least, an area over the center of the long side concerned. The height of the rib is set to be lowest at opposite ends thereof.

### FIELD OF THE INVENTION

The present invention relates to a resin molded article which is formed by pouring a molten resin into a mold.

### BACKGROUND OF THE INVENTION

A resin molded article formed by pouring a molten resin into a mold has been widely used. There is a technique disclosed in Patent Literature Document 1 as a conventional technology relating to such a resin molded article.

The resin molded article shown in Patent Literature Document 1 is manufactured by detecting the deflection during injection of the resin and adjusting the pressure and flow rate of a plastic material to be injected.

### LISTING OF PRIOR ART REFERENCES

### Patent Literature Documents

Patent Literature Document 1: Japanese Patent Application Laid-Open Publication No. 2019-55586

### SUMMARY OF THE INVENTION

### Problems to be Solved by the Invention

When the resin molded article disclosed in Patent Literature Document 1 is manufactured, control for adjusting the pressure and the flow rate of the plastic material is performed, and therefore the manufacturing cost of the resin molded article is increased. It is desired to provide a resin molded article formed in a predetermined shape at a low cost.

An object of the present invention is to provide a resin molded article formed in a predetermined shape at a low cost.

### Solution to the Problems

According to one aspect of the present invention, there is provided a resin molded article that includes:

a plate portion, which defines one face of a main body formed in a rectangular cylinder shape, the main body having an opening, at least, at one end of the main body, the plate portion having a substantially rectangular plate shape; and

at least one rib which is integrally raised from the plate portion,

wherein when sides of the plate portion, which are adjacent to the opening, are taken as opening sides, each of at least one rib is formed along at least one of the opening sides such that each rib includes at least an area over a center of the opening side concerned, and

a height of each rib is set such that the rib is lowest at opposite ends of the rib.

According to another aspect of the present invention, there is provided a resin molded article that includes:

a plate portion formed in a substantially rectangular plate shape, and

a rib which is integrally raised from the plate portion,

the plate portion body having a pair of long sides facing each other, and a pair of short sides facing each other, the short sides being shorter than the long sides,

the rib being formed along at least one of the long sides such that the rib includes at least an area over a center of the long side, and

a height of the rib being set such that the rib is lowest at opposite ends of the rib.

According to yet another aspect of the present invention, there is provided a resin molded article that includes:

a main body formed in a rectangular cylinder shape and having an opening, at least, at one end of the main body, the main body being defined by four plate portions, each of the plate portions being a substantially rectangular plate;

two ribs formed on two of the four plate portions facing each other, respectively, such that each of the two ribs is integrally raised from one side of the plate portion concerned, the one side being an opening side that extends adjacent to the opening of the main body; and

second ribs which are integrally raised from the remaining two of the four plate portions such that the second ribs connect the two ribs to each other,

each of the two ribs being longer than each of the second ribs, and being formed in an arch shape such that the rib is highest at a center of the opening side and lowest at opposite ends of the rib, and

a value obtained by dividing a difference between a highest height at a site where a height of the rib is highest and a lowest height at another site where the height of the rib is lowest by a length of the rib being taken as a curvature, and the curvature being set to be 0.01 or more.

### Advantageous Effects of the Invention

In the present invention, the height of the rib is set such that the rib is lowest at the opposite ends of the rib. It was found that the displacement amount became smaller in the configuration that had the rib whose height was made shorter at its opposite ends than a configuration that had a rib whose height was the same for its entirety. By providing the resin molded article with the rib whose height is lower at the opposite ends, it is possible to obtain a resin molded article formed in a predetermined shape while being inexpensive.

### BRIEF DESCRIPTION OF THE DRAWINGS

FIG. 1 is a perspective view of a resin molded article according to a first embodiment of the present invention.

FIG. 2A is a diagram when viewed in the direction of the arrow 2A in FIG. 1

FIG. 2B is a diagram useful to describe a plate-shaped injection molded article according to a comparative example.

FIG. 3 is a perspective view of an air conditioner blowing unit (air outlet unit) using a resin molded article according to a second embodiment.

FIG. 4 is a front view of the resin molded article shown in FIG. 3.

FIG. 5A is a diagram useful to describe a test piece according to Experiment No. 1.

FIG. 5B is a diagram useful to describe a test piece according to Experiment No. 2.

FIG. 5C is a diagram useful to describe a test piece according to Experiment No. 3.

FIG. 6 is a diagram useful to describe an amount of displacement in the experiments.

FIG. 7A is a diagram useful to describe a test piece according to Experiment No. 4.

FIG. 7B is a diagram useful to describe a test piece according to Experiment No. 5.

FIG. 7C is a diagram useful to describe a test piece according to each of Experiment Nos. 6, 7 and 10-25.

FIG. 8A is a diagram useful to describe a test piece according to Experiment No. 8.

FIG. 8B is a diagram useful to describe a test piece according to Experiment No. 9.

FIG. 9 is a diagram useful to describe a test piece according to each of Experiment No. 26-28.

### DETAILED DESCRIPTION OF THE PREFERRED EMBODIMENTS

Embodiments of the present invention will be described below with reference to the accompanying drawings. Incidentally, in the following description, the terms “left” and “right” refer to the left and right when viewed from a person in a vehicle, and the terms “front” and “rear” refer to the front and rear when viewed in the traveling direction of the vehicle. In addition, “Fr” in the drawing presents the front, “Rr” represents the rear, “Le” represents the left when viewed from the person in the vehicle, “Ri” represents the right when viewed from the person in the vehicle, “Up” represents the top or up, and “Dn” represents the bottom or down.

### First Embodiment

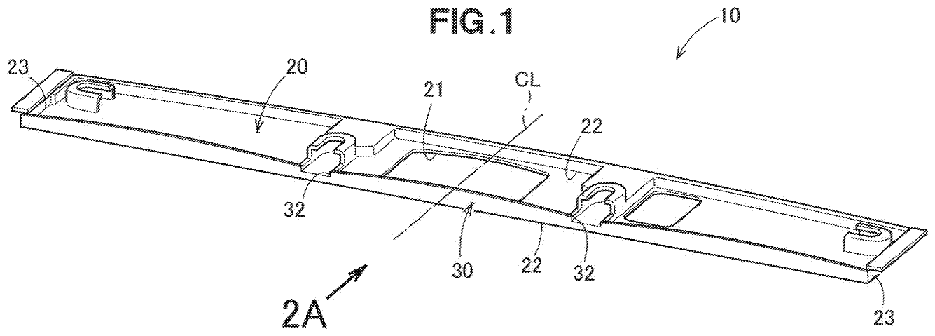

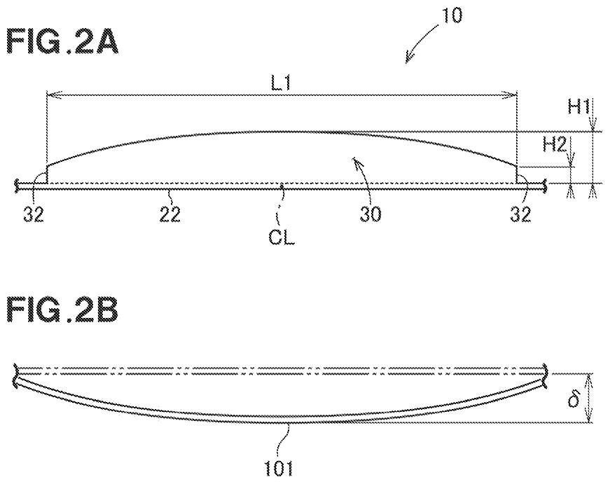

Referring to FIG. 1 and FIG. 2A, a license plate 10 mounted on a rear of a vehicle is shown. It can be said that the license plate 10 is a resin molded article 10 formed by injection molding. Hereinafter, the license plate 10 is referred to as the resin molded article 10.

The resin molded article 10 includes a plate portion (plate main body) 20 formed in a substantially rectangular plate shape, and a rib 30 which is integrally raised from the plate main body 20.

The plate main body 20 has a substantially rectangular hole 21 made in the center of the plate main body 20. The plate main body 20 has a pair of long sides 22, 22 facing each other, and a pair of short sides 23, 23 facing each other. The short sides 23, 23 are shorter than the long sides 22, 22.

Referring to FIG. 2A, the rib 30 is formed along one of the long sides 22 (the long side 22 closer to a reader of the specification). The rib 30 is formed to include an area over the center CL of the long side 22. The length of the rib 30 in the direction of the long side of the rib 30 is L1. The rib 30 is generally formed in an arch shape because the top of the rib bends in a substantially arcuate shape. The height of the rib 30 is set such that the height of the rib 30 is highest at the center CL and indicated by H1, and lowest at the opposite ends 32 and 32 and indicated by H2.

Here, the difference between the height H2 of the rib 30 at the opposite ends 32 and 32 of the long side 22 and the height H1 of the rib 30 at the central CL of the long side 22 is by divided by the length L1 from one end 32 of the rib 30 to the other end 32, and the resultant is defined as the curvature. The curvature is preferably 0.01 or more. In other words, it is preferred that the relation of (H1−H2)/L1≥0.01 holds.

Referring to FIG. 2B, a plate-shaped injection molded article 101 according to a comparative example is shown. It was confirmed that the plate-shaped injection molded article 101 deflects by δ with respect to the plane indicated by the double chain line. In other words, the double chain line is the ideal shape of the injection molded article 101. The actual injection-molded article is deflected from the ideal shape by δ. δ is called the deflection amount or displacement amount.

Referring to FIG. 2A, the height of the rib 30 of the resin molded article 10 is set to be lowest at opposite ends 32 and 32 (H2). Compared to the configuration that has the rib having the same height for its entirety, it was found that the displacement amount δ became smaller when the height of each of the ends 32 and 32 of the rib 30 was reduced (see FIG. 2B). By providing the resin molded article 10 with the rib 30 whose ends 32 and 32 have reduced height, it is possible to manufacture a resin molded article 10 formed in a predetermined shape at an inexpensive cost.

The upper end (upper edge) of the rib 30 has a generally curved arch shape. This shape further reduced the displacement amount.

### Second Embodiment

Next, a second embodiment of the present invention will be described based on the drawings.

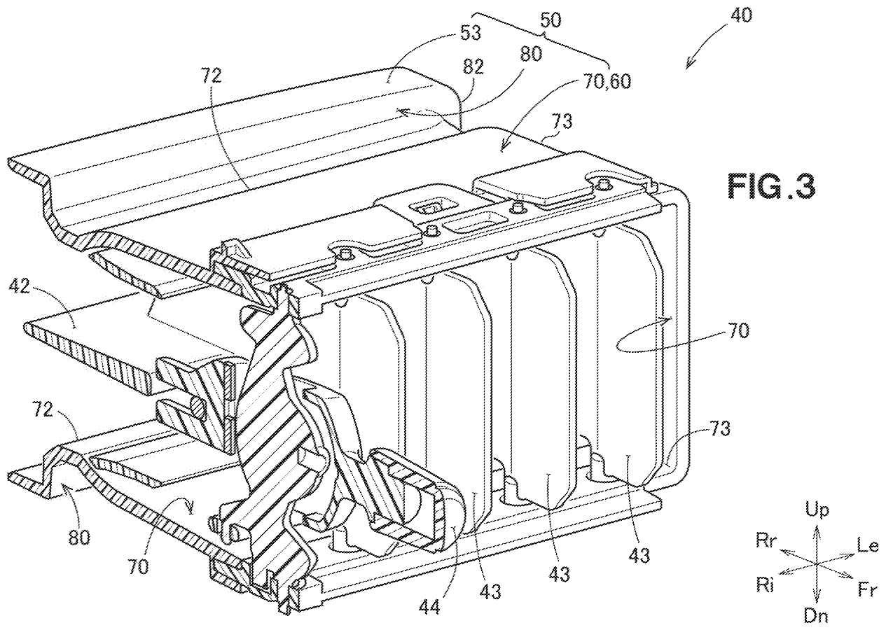

Referring to FIG. 3, shown is an air conditioner blowing unit (air outlet unit) 40 that is directed toward a person (or persons) in the vehicle. The air conditioner blowing unit 40 is fitted into a dashboard provided in a front area of a vehicle's interior, and is used as an air outlet of the cold air or hot air to the vehicle's interior.

The air conditioner blowing unit 40 includes a cylindrical body 50 formed in a substantially rectangular cylinder shape. Fins 42 and 43 for changing the wind direction (air blowing direction) are provided in the cylindrical body 50, and an operation knob 44 for adjusting the directions of the fins 42 and 43 is also provided in the cylindrical body 50.

The cylindrical body 50 can be referred to as a resin molded article 50 formed by injection molding. Hereinafter, the cylindrical body 50 is referred to as the resin molded article 50.

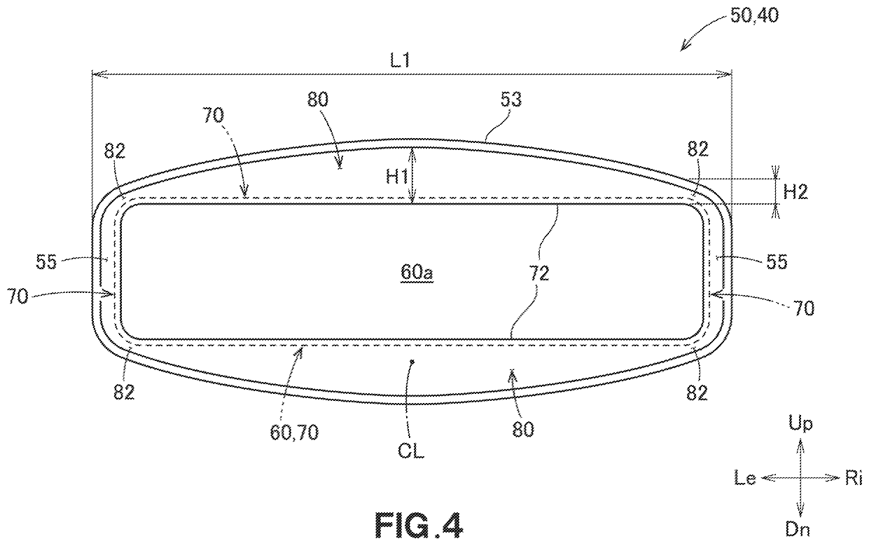

Referring also to FIG. 4, the resin molded article 50 includes a main body 60 which is formed in a rectangular cylinder shape and are open at both ends thereof, ribs 80 which are integrally raised from the main body 60, and extending portions 53 which start from the distal ends (front ends) of the respective ribs 80 and extend apart from the main body 60. The extending portions 53 are formed substantially in parallel to the main body 60.

The main body 60 is constituted by four plate portions 70. Each of the plate portions 70 is a substantially rectangular plate-shaped portion. One of the plate portions 70 that constitutes the upper surface of the main body 60 has a pair of long sides 72 and 72 facing each other, and a pair of short sides 73 and 73 facing each other. The short sides 73 and 73 are shorter than the long sides 72 and 72. In the drawing, the left short side 73 is only shown. The long sides 72 and 72 can also be referred to as opening sides 72 and 72 adjacent to the opening 60a. In other words, the long sides 72 and 72 of the main body 60 are the opening sides 72 and 72 of the main body 60.

The rib 80 is formed along the front opening side 72 such that the rib 80 becomes an upper portion for the entirety of the front opening side 72. The length of the rib 80 in the direction along the long side of the rib 80 is L1. The upper surface (edge) of the rib 80 bends in a substantially arcuate shape, and therefore the entirety of the rib 80 is formed in a substantially arched shape. The height of the rib 80 is set such that the height of the rib 80 is highest at the center CL and indicated by H1, and lowest at opposite ends 82 and 82 and indicated by H2.

The curvature of the rib 80 is preferably 0.01 or more. In other words, it is preferred that the relation of (H1−H2)/L1≥0.01 holds.

Similarly, the rib 80 is formed at the front opening side 72 of the lower plate portion 70. Second ribs 55 and 55 are integrally formed at the front ends of the left and right plate portions 70, respectively. The upper and lower ribs 80 and 80 are connected to each other by the second ribs 55 and 55. The ribs 80, 80 and the second ribs 55, 55 are continuous and formed integrally.

The extending portions 53 extend generally perpendicular to the ribs 80, 80 and the second ribs 55, 55. The extending portions 53 are formed continuously in the circumferential direction from the edges of the ribs 80, 80 and the second ribs 55, 55.

It should be noted that although it is preferred that the ribs 80 are formed along the entire long sides and opening sides 72, it may be satisfactory that the ribs 80 are formed, at least, over the centers of the opening sides 72, respectively.

In addition, one end of the main body 60 may be closed by a bottom of the main body. In this configuration, the ribs 80 are formed at the end where the plate portions 70 defines the opening 60a. That is, the ribs 80 are formed along the opening sides 72.

The height of each of the ribs 80 of the resin molded article 50 is set such that the height is lowest at the opposite ends 82 and 82 (H2). Compared to the configuration that has the ribs having the same height for its entirety, it was found that the displacement amount δ became smaller when the height of each of the ends 82 and 82 of each rib 80 was reduced (see FIG. 2B). By providing the resin molded article 50 with the ribs 80 whose ends 82 and 82 have reduced height, it is possible to manufacture a resin molded article 50 formed in a predetermined shape at an inexpensive cost.

The upper end of each of the ribs 80 has a generally curved arch shape. This shape further reduces the displacement amount.

The resin molded article 50 also includes the extending portions 53 that extend generally perpendicular to the ribs 80 and 80. The extending portions 53 start extending from the front ends of the ribs 80 and 80. Thus, it is possible to further reduce the displacement amount.

Incidentally, when manufacturing the resin molded article 50, the resin is injected into a cavity through a gate. The position of the gate may be decided such that the gate faces a position corresponding to a flange of the cavity or may be a far position offset from the position corresponding to the flange.

### Experimental Examples

The inventors of this patent application have conducted experiments on resin molded articles. The experiments conducted by the inventors will be described below with reference to the tables and the drawings.

TABLE 1

| | | | | | | RIB | RIB |
|---|---|---|---|---|---|---|---|
| | | | | OPENING | | MAXIMUM | MINIMUM |
| EXPERIMENT | | LENGTH | THICKNESS | HEIGHT | | HEIGHT | HEIGHT |
| NO. | SHAPE | (mm) | (mm) | (mm) | SHAPE OF THE RIB | (mm) | (mm) |
| 1 | PLATE | 120 | 2.5 | — | — | 0 | 0 |
| 2 | | | | — | RECTANGULAR | 5 | 5 |
| 3 | | | | — | ARCH | 5 | 5 |
| 4 | RECTANGULAR | 141 | 2 | 26 | RECTANGULAR | 5 | 5 |
| 5 | CYLINDER | | | | RECTANGULAR + | 5 | 5 |
| | | | | | [symbol] | | |
| 6 | | | | | ARCH | 7 | 5 |
| 7 | | | | | | 7 | 5 |
| 8 | | | | | PENTAGON | 7 | 5 |
| 9 | | | | | HEXAGON | 7 | 5 |

| | | SECOND | | | | |
|---|---|---|---|---|---|---|
| | HEIGHT | RIB | | | DISPLACEMENT | |
| EXPERIMENT | DIFFERENCE | WIDTH | EXTENDING | | AMOUNT | |
| NO. | (mm) | (mm) | PORTIONS | CURVATURE | (mm) | EVALUATION |
| 1 | 0 | — | NOT FORMED | 0 | 0.35 | ◯ |
| 2 | 0 | — | NOT FORMED | 0 | 1.6 | X |
| 3 | 2 | — | NOT FORMED | 0.017 | 1.4 | ◯ |
| 4 | 0 | 5 | FORMED | 0 | 0.3 | ◯ |
| 5 | 0 | 5 | FORMED | 0 | 0.16 | ◯ |
| 6 | 2 | 5 | FORMED | 0.014 | 0.05 | ⊚ |
| 7 | 2 | 5 | NOT FORMED | 0.014 | 0.12 | ⊚ |
| 8 | 2 | 5 | FORMED | 0.014 | 0.09 | ⊚ |
| 9 | 2 | 5 | FORMED | 0.014 | 0.12 | ⊚ |

[symbol]

indicates data missing or illegible when filed

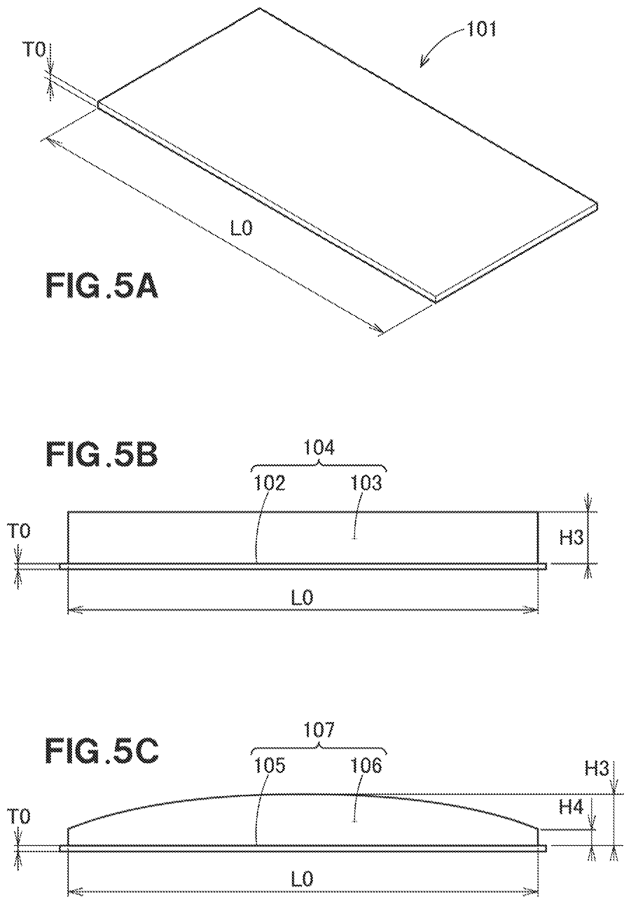

Reference is made to FIG. 5A. In Experiment No. 1, a substantially rectangular plate-shaped resin molded article 101 was prepared and used. The resin molded article 101 was formed by injection molding. The length L0 of the resin molded article 101 is 120 mm. The plate thickness T0 is 2.5 mm. Since the resin molded article 101 is the plate-shaped resin molded article, an opening (see FIG. 4, reference numeral 60a) is not formed. Ribs (see FIG. 4, reference numeral 80) were not formed. Therefore, the rib maximum height which is the height at the highest position of the rib is 0 mm, the rib minimum height which is the height at the lowest position of the rib is 0 mm, and the height difference between the rib maximum height and the rib minimum height is 0 mm. The second ribs (see FIG. 4, reference numeral 55) were not formed. Therefore, the second rib width, which is the width of the second rib, was 0 mm. The extending portions (see FIG. 4, reference numeral 53) were not formed. The curvature obtained by dividing the height difference of the rib by the length from one end of the rib to the other end was 0.

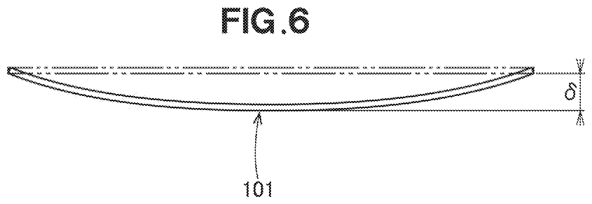

Referring to FIG. 6, the displacement amount δ of the resin molded article 101 of Experiment No. 1 from the flat plate indicated by the double chain line was 0.35 mm. The evaluation of Experiment No. 1 was good (O) because the displacement amount was smaller than a reference value, i.e., 1.5 mm.

Incidentally, the plate-shaped resin molded article 101 greatly deflects during transportation and assembly, and also greatly deflects after assembly. Therefore, it is preferable to add a rib (or ribs) that stands from the surface of the resin molded article to enhance the strength. With this configuration, i.e., even when forming the rib(s), it is desired that the displacement amount is small. The inventors have conducted further experiments on how the displacement amount is reduced by forming the rib(s).

Reference is made to FIG. 5B. In Experiment No. 2, a resin molded article 104 that had a substantially rectangular plate 102 and a substantially rectangular rib 103 formed over the length direction of the plate 102 was prepared and used. The length L0 of the rib 103 is 120 mm, and the plate thickness T0 is 2.5 mm. The shape of the rib 103 is generally rectangular, and the rib maximum height H3 and the rib minimum height are both 5 mm. Therefore, the height difference is 0 mm. The second ribs were not formed, and the extending portions were not formed. The curvature was 0. The displacement amount of the resin molded article 104 of Experiment No. 2 was 1.6 mm and greater than the reference value, i.e., 1.5 mm. Thus, the evaluation Experiment No. 2 was no good (x).

Reference is made to FIG. 5C. In Experiment No. 3, a resin molded article 107 that has a substantially rectangular plate 105 and a substantially rectangular rib 106 formed over the length direction of the plate 105 was prepared and used. The length L0 of the rib 106 is 120 mm, and the plate thickness T0 is 2.5 mm. The shape of the ribs 106 is an arch, with the height of the center being highest. The rib maximum height H3 is 5 mm at the center and the rib minimum height H4 is 3 mm at both ends. The difference between the rib maximum height and the rib minimum height is 2 mm. The second ribs were not formed, and the extending portions were not formed. The curvature obtained by dividing the height difference of the rib by the length from one end of the rib to the other end was 0.017. The displacement amount of the resin molded article 107 of Experiment No. 3 was 1.4 mm and smaller than the reference value, i.e., 1.5 mm. Thus, the evaluation Experiment No. 3 was good (O).

Referring also to FIG. 5B, if the resin molded article 104 according to Experiment No. 2 and the resin molded article 107 according to Experiment No. 3 are compared with each other, the shape of the rib 103 is different from the shape of the rib 106. The displacement amount of the resin molded article 107 according to Experiment No. 3, whose ends are shorter than the center was smaller than the displacement amount of Experiment No. 2.

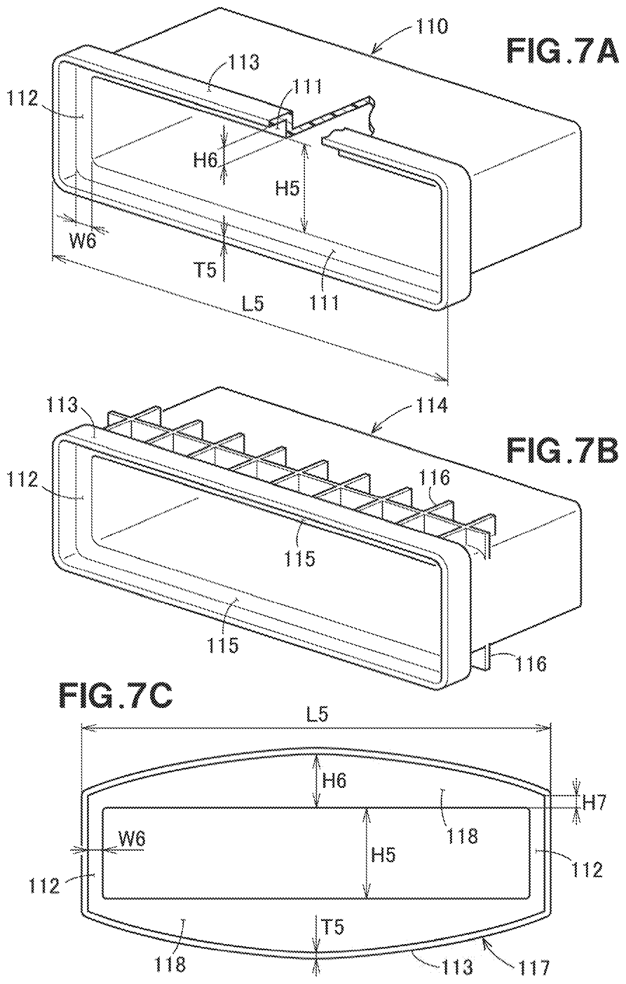

Reference is made to FIG. 7A. In Experiment No. 4, a resin molded article 110 that has a rectangular cylinder shape, with both ends being open, was prepared and used. A substantially rectangular rib 111 having a length L5 of 141 mm was formed. The plate thickness T5 is 2 mm, and the opening height H5 is 26 mm. The rib maximum height H6 is 5 mm, and the rib minimum height is the same (i.e., 5 mm). The height difference is 0 mm, and the second rib width W6, which is the width of the second rib 112, is 5 mm. Since the extending portions 113 are formed, the answer to the “presence or absence” of the extending portions is the presence. The curvature is 0. The displacement amount of the resin molded article of Experiment No. 4 was 0.3 mm, and the evaluation of Experiment No. 4 was good (O).

Referring to FIG. 7B, a resin molded article 114 of Experiment No. 5 has a reinforcing rib 116 behind the rib 115. Other conditions of Experiment No. 5 are the same as Experiment No. 4. The displacement amount of the resin molded article 114 of Experiment No. 5 was 0.16 mm, and the evaluation of Experiment No. 5 was good (O).

Referring to FIG. 7C, a resin molded article 117 of Experiment No. 6 has an arch-shaped rib 118 formed thereon. The rib maximum height H6 is 7 mm, the rib minimum height H7 is 5 mm, the height difference is 2 mm, and the curvature is 0.014. Other conditions of Experiment No. 6 are the same as Experiment No. 4. The displacement amount of the resin molded article 117 of Experiment No. 6 was 0.05 mm. Since the displacement amount is no greater than 0.15 mm, Experiment No. 6 is particularly preferred. Therefore, the evaluation of Experiment No. 6 is excellent (double circle).

Comparing Experiment No. 5 with Experiment No. 6, the shapes of the ribs are different. The displacement amount of Experiment No. 6 in which the height of both ends of the rib was smaller than the center was smaller than the displacement amount of Experiment No. 5 in which the reinforcing rib was formed.

The resin molded article of Experiment No. 7 is different from the resin molded article 117 of Experiment No. 6 in that it does not form the extending portions 113. Other conditions of Experiment No. 7 are the same as Experiment No. 6. The displacement amount of the resin molded article of Experiment No. 7 was 0.12 mm, and the evaluation of Experiment No. 7 was excellent (double circle).

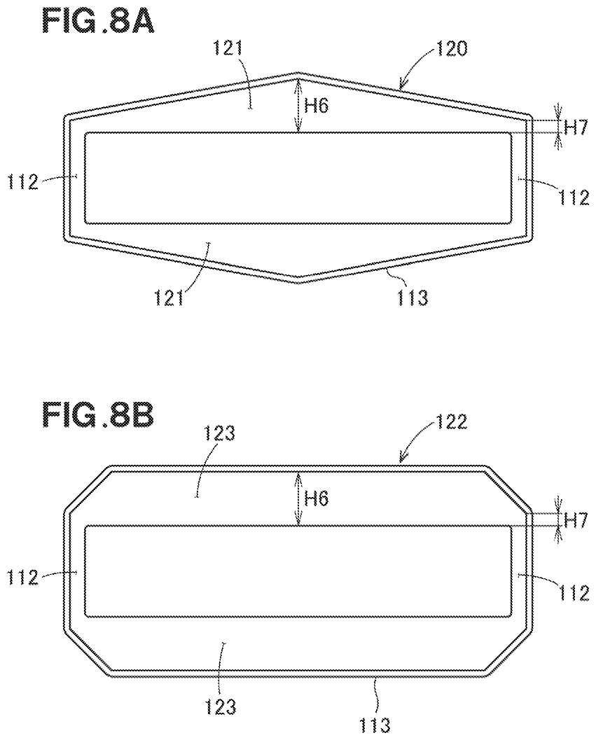

Referring to FIG. 8A, a resin molded article 120 of Experiment No. 8 has a rib 121 that is formed in a substantially pentagonal shape. The rib 121 extends linearly from the center, which is indicated by the maximum height H6, to both ends which are indicated by the minimum height H7. Other conditions of Experiment No. 8 are the same as Experiment No. 6. The displacement amount of the resin molded article of Experiment No. 8 was 0.09 mm, and the evaluation of Experiment No. 8 was excellent (double circle).

Referring to FIG. 8B, a resin molded article 122 of Experiment No. 9 has a rib 123 that is formed in a substantially hexagonal shape. The portion of the rib 122 having the maximum height H6 extends in the right-and-left direction, and extends obliquely from the vicinity of both ends to both end portions having the minimum height H7. Other conditions of Experiment No. 9 are the same as Experiment No. 6. The displacement amount of the resin molded article of Experiment No. 9 was 0.12, and the evaluation of Experiment No. 9 was excellent (double circle).

Experiment Nos. 6, 8 and 9 were conducted with different shapes of the ribs, respectively. The displacement was the smallest in Experiment No. 6 that had the rib in the arch shape.

TABLE 2

| | | | | | | RIB | RIB |
|---|---|---|---|---|---|---|---|
| | | | | OPENING | | MAXIMUM | MINIMUM |
| EXPERIMENT | | LENGTH | THICKNESS | HEIGHT | | HEIGHT | HEIGHT |
| NO. | SHAPE | (mm) | (mm) | (mm) | SHAPE OF THE RIB | (mm) | (mm) |
| 10 | RECTANGULAR | 141 | 2 | 26 | ARCH | 5.5 | 5 |
| 11 | CYLINDER | | | | | 6 | 5 |
| 12 | | | | | | 6.5 | 5 |
| 13 | | | | | | 7.5 | 5 |
| 14 | | | | | | 8 | 5 |
| 15 | | | | | | 8.5 | 5 |
| 16 | | | | | | 10 | 5 |
| 17 | | | | | | 15 | 5 |
| 18 | | | | | | 20 | 5 |
| 19 | | | | | | 8 | 5 |
| 20 | | | | | | 11 | 5 |
| 21 | | | | 31 | | 7 | 5 |
| 22 | | 70.5 | | 26 | | 6 | 5 |
| 23 | | 211.5 | | | | 8 | 5 |
| 24 | | 141 | | | | 5 | 3 |
| 25 | | | | | | 9 | 7 |
| 26 | RECTANGULAR | 230 | 2.5 | 150 | — | 0 | 0 |
| 27 | [symbol] | | | | RECTANGULAR | 10 | 10 |
| 28 | [symbol] | | | | ARCH | 10 | 5 |

| | | SECOND | | | | |
|---|---|---|---|---|---|---|
| | HEIGHT | RIB | | | DISPLACEMENT | |
| EXPERIMENT | DIFFERENCE | WIDTH | EXTENDING | | AMOUNT | |
| NO. | (mm) | (mm) | PORTIONS | CURVATURE | (mm) | EVALUATION |
| 10 | 0.5 | 5 | NOT FORMED | 0.004 | 0.16 | ◯ |
| 11 | 1 | 5 | NOT FORMED | 0.007 | 0.17 | ◯ |
| 12 | 1.5 | 5 | NOT FORMED | 0.01 | 0.12 | ⊚ |
| 13 | 2.5 | 5 | NOT FORMED | 0.018 | 0.11 | ⊚ |
| 14 | 3 | 5 | NOT FORMED | 0.021 | 0.11 | ⊚ |
| 15 | 3.5 | 5 | NOT FORMED | 0.025 | 0.08 | ⊚ |
| 16 | 5 | 5 | NOT FORMED | 0.035 | 0.06 | ⊚ |
| 17 | 10 | 5 | NOT FORMED | 0.071 | 0.02 | ⊚ |
| 18 | 15 | 5 | NOT FORMED | 0.106 | 0 | ⊚ |
| 19 | 3 | 5 | FORMED | 0.021 | 0.06 | ⊚ |
| 20 | 6 | 5 | FORMED | 0.043 | 0.03 | ⊚ |
| 21 | 2 | 5 | FORMED | 0.014 | 0.06 | ⊚ |
| 22 | 1 | 5 | FORMED | 0.014 | 0.02 | ⊚ |
| 23 | 3 | 5 | FORMED | 0.014 | 0.11 | ⊚ |
| 24 | 2 | 1 | FORMED | 0.014 | 0.11 | ⊚ |
| 25 | 2 | 5 | FORMED | 0.014 | 0.05 | ⊚ |
| 26 | 0 | 0 | NOT FORMED | — | 28.49 | X |
| 27 | 0 | 10 | NOT FORMED | 0 | 1.98 | X |
| 28 | 5 | 5 | NOT FORMED | 0.022 | 0.12 | ⊚ |

[symbol]

indicates data missing or illegible when filed

In Experiment Nos. 10-18, experiments were conducted on resin molded articles that were prepared by changing the maximum height of the rib of the resin molded article of Experiment No. 7. Therefore, the conditions of Experiment Nos. 10-18 are different from the conditions of Experiment No. 7 in the rib maximum height, the height difference, and the curvature. Other conditions of Experiment Nos. 10-18 are common to Experiment No. 7. For the common conditions, the description will be omitted.

In Experiment No. 10, the rib maximum height was 5.5 mm, the height difference was 0.5 mm, and the curvature was 0.004. The displacement amount of the resin molded article of Experiment No. 10 was 0.16 mm, and the evaluation of Experiment No. 10 was good (O).

In Experiment No. 11, the rib maximum height was 6 mm, the height difference was 1 mm, and the curvature was 0.007. The displacement amount of the resin molded article of Experiment No. 11 was 0.17 mm, and the evaluation of Experiment No. 11 was good (O).

In Experiment No. 12, the rib maximum height was 6.5 mm, the height difference was 1.5 mm, and the curvature was 0.01. The displacement amount of the resin molded article of Experiment No. 12 was 0.12 mm, and the evaluation of Experiment No. 12 was excellent (double circle).

In Experiment No. 13, the rib maximum height was 7.5 mm, the height difference was 2.5 mm, and the curvature was 0.018. The displacement amount of the resin molded article of Experiment No. 13 was 0.11 mm, and the evaluation of Experiment No. 13 was excellent (double circle).

In Experiment No. 14, the rib maximum height was 8 mm, the height difference was 3 mm, and the curvature was 0.021. The displacement amount of the resin molded article of Experiment No. 14 was 0.11 mm, and the evaluation of Experiment No. 14 was excellent (double circle).

In Experiment No. 15, the rib maximum height was 8.5 mm, the height difference was 3.5 mm, and the curvature was 0.025. The displacement amount of the resin molded article of Experiment No. 15 was 0.08 mm, and the evaluation of Experiment No. 15 was excellent (double circle).

In Experiment No. 16, the rib maximum height was 10 mm, the height difference was 5 mm, and the curvature 0.035. The displacement amount of the resin molded article of Experiment No. 16 was 0.06 mm, and the evaluation of Experiment No. 16 was excellent (double circle).

In Experiment No. 17, the rib maximum height was 15 mm, the height difference was 10 mm, and the curvature was 0.071. The displacement amount of the resin molded article of Experiment No. 17 was 0.02 mm, and the evaluation of Experiment No. 17 was excellent (double circle).

In Experiment No. 18, the rib maximum height was 20 mm, the height difference was 15 mm, and the curvature was 0.106. The displacement amount of the resin molded article of Experiment No. 18 was 0 mm, and the evaluation of Experiment No. 18 was excellent (double circle).

In Experiment Nos. 19 and 20, experiments were conducted on resin molded articles that were prepared by changing the maximum height of the rib of the resin molded article of Experiment No. 6. Therefore, the conditions of Experiment Nos. 19 and 20 are different from the conditions of Experiment No. 6 in the rib maximum height, the height difference, and the curvature. Other conditions of Experiment Nos. 19 and 20 are common to Experiment No. 6. For the common conditions, the description will be omitted.

In Experiment No. 19, the rib maximum height was 8 mm, the height difference was 3 mm, and the curvature was 0.021. The displacement amount of the resin molded article of Experiment No. 19 was 0.06 mm, and the evaluation of Experiment No. 19 was excellent (double circle).

In Experiment No. 20, the rib maximum height was 11 mm, the height difference was 6 mm, and the curvature was 0.043. The displacement amount of the resin molded article of Experiment No. 20 was 0.03 mm, and the evaluation of Experiment No. 20 was excellent (double circle).

In Experiment No. 21, an experiment was conducted on a resin molded article that was prepared by changing the opening height of the resin molded article of Experiment No. 6. Other conditions of Experiment No. 21 are common to Experiment No. 6. For the common conditions, the description will be omitted.

In Experiment No. 21, the opening height was 31 mm. The displacement amount of the resin molded article of Experiment No. 21 was 0.06 mm, and the evaluation of Experiment No. 21 was excellent (double circle).

In Experiment Nos. 22 and 23, experiments were conducted on resin molded articles that were prepared by changing the length and the rib maximum height of the resin molded article of Experiment No. 6. Therefore, the conditions of Experiment No. 22 and 23 are different from the conditions of Experiment No. 6 in the length, the rib maximum height, and the height difference. On the other hand, the curvature is the same. Other conditions of Experiment Nos. 22 and 23 are also common to Experiment No. 6. For the common conditions, the description will be omitted.

In Experiment No. 22, the length was 70.5 mm, the rib maximum height was 6 mm, and the height difference was 1 mm. The displacement amount of the resin molded article of Experiment No. 22 was 0.02 mm, and the evaluation of Experiment No. 22 was excellent (double circle).

In Experiment No. 23, the length was 211.5 mm, the rib maximum height was 8 mm, and the height difference was 3 mm. The displacement amount of the resin molded article of Experiment No. 23 was 0.11 mm, and the evaluation of Experiment No. 23 was excellent (double circle).

In Experiment Nos. 24 and 25, experiments were conducted on resin molded articles that were prepared by changing the rib maximum height, the rib minimum height, and the second rib width (see FIG. 7C, reference numeral W6) of the resin molded article of Experiment No. 6. On the other hand, the curvature is the same. Other conditions of Experiment Nos. 24 and 25 are also common to Experiment No. 6. For the common conditions, the description will be omitted.

In Experiment No. 24, the rib maximum height was 5 mm, the rib minimum height was 3 mm, and the second rib width was 1 mm. The displacement amount of the resin molded article of Experiment No. 24 was 0.11 mm, and the evaluation of Experiment No. 24 was excellent (double circle).

In Experiment No. 25, the rib maximum height was 9 mm, the rib minimum height was 7 mm, and the second rib width was 5 mm. The displacement amount of the resin molded article of Experiment No. 24 was 0.05 mm, and the evaluation of Experiment No. 25 was excellent (double circle).

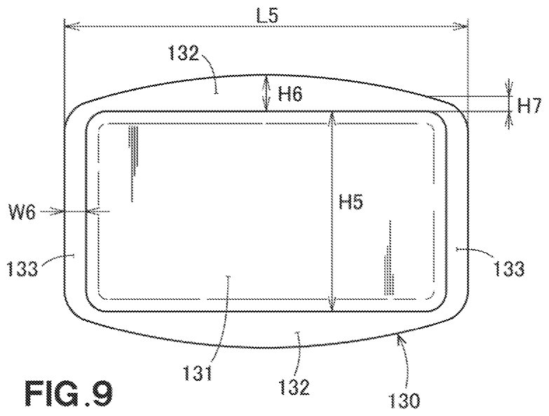

Referring to FIG. 9, each of Experiment Nos. 26-28 used a resin molded article 130, with one end thereof being closed by a bottom 131. When forming the ribs 132 and the second ribs 133, the ribs were formed along the other end which is open. The length L5 is 230 mm, the plate thickness is 2.5 mm, and the opening height H5 is 150 mm for all of Experiment Nos. 26-28. The extending portions were not formed.

In Experiment No. 26, the ribs were not formed, and the second ribs were not formed. The displacement amount of the resin molded article according to Experiment No. 26 was 28.49 mm, and the evaluation of Experiment No. 26 was no good (x).

In Experiment No. 27, rectangular ribs were formed. The rib maximum height H6 is 10 mm, and the rib minimum height is the same. The height difference is 0 mm, and the second rib width W6, which is the width of the second rib 133, is 10 mm. The curvature is 0. The displacement amount of the resin molded article of Experiment No. 27 was 1.98 mm, and the evaluation of Experiment No. 27 was no good (x).

The resin molded article 130 of Experiment No. 28 has ribs 132 that are in the arch shape. The rib maximum height H6 is 10 mm, the rib minimum height H7 is 5 mm, the height difference is 5 mm, and the curvature is 0.022. The displacement amount of the resin molded article 130 of Experiment No. 28 was 0.12 mm, and the evaluation was excellent (double circle).

From the above-mentioned experimental results, the following can be said.

Referring to FIG. 1 and FIG. 2, the resin molded article 10 includes the plate main body (plate portion) 20 formed in the substantially rectangular plate shape, and the rib 30 which is integrally raised from the plate main body 20,

the plate main body 20 includes a pair of long sides 22, 22 facing each other, and a pair of short sides 23, 23 facing each other, the short sides 22, 23 being shorter than the long sides 22, 22,

the rib 30 is formed such that the rib 30 extends along the long side 22 and includes, at least, an area over the center CL of the long side 22, and

the height of the rib 30 is set such that the rib 30 is lowest at the opposite ends 32 and 32 of the rib.

Referring to FIG. 3 and FIG. 4, the main body 60 of the resin molded article 50 is formed in the rectangular cylinder shape and is open, at least, at one end thereof, one face of the main body 60 is defined by the plate portion 70 formed in the substantially rectangular plate, and the a rib 80 is integrally raised from the plate portion 70,

when the sides adjacent to the opening 60a among the sides of the plate portion 70 are referred to as opening sides 72,

the ribs 80 are formed along the opening sides 72, respectively, such that each rib 80 extends along the associated opening side 72 and includes, at least, an area over the center CL of the opening side 72 concerned, and

the height of each of the ribs 80 is set such that the height of the rib is lowest at the opposite ends 82 and 82 of the rib.

If the difference between the height H2 of the rib 80 at the opposite ends 82 and the height H1 of the rib 80 at the central CL of the opening side 72 is divided by the length L1 from one end 82 of the rib 80 to the other end 82 and the resultant is referred to as the curvature, the curvature is preferably 0.01 or more.

The upper end of the rib 80 preferably has a generally curved arch shape.

It is preferred that the resin molded article 50 also includes the extending portions 53 such that each of the extending portions 53 extends from the upper end of each of the ribs 80 in a direction substantially perpendicular to the rib 80.

The resin molded article 50 includes:

the main body 60, which is formed in the rectangular cylinder shape and is open, at least, at one end thereof, the main body 60 being defined by the four plate portions 70, each of the four plate portions 70 being a substantially rectangular plate,

the two ribs 80 formed on the two plate portions 70 facing each other among the four plate portions 70, respectively, such that each of the ribs is formed along one side 72 of the plate portion concerned and integrally raised from the side 72, with the side 72 being the side that extends adjacent to the opening 60a formed by the four plate portions 70, and

the second ribs 55 integrally raised from the remaining two plate portions 70 such that the second ribs 55 connect the ribs 80 to each other,

each of the ribs 80 being longer than each of the second ribs 55, and being formed in an arched shape such that the rib 80 is highest at the center of the opening side 72 and lowest at the opposite ends of the opening side, and

the curvature being set to be 0.01 or more if the curvature is a value obtained by dividing the difference between the highest height H1 at the site where the height of the rib 80 is highest and the lowest height H2 at the site where the height of the rib 80 is lowest by the length L1 of the rib 80.

Furthermore, it is preferred that the resin molded article 50 further includes the extending portions 53 such that the extending portions 53 extend from the front ends of the ribs 80 and from the free ends of the second ribs 55 in a direction away from the plate portions 70, and

the extending portions 53 are formed continuously in the circumferential direction so as to surround the opening 60a.

Incidentally, each of the second ribs 55 and 133 may be formed in an arch shape, a pentagonal shape, a hexagonal shape or the like, with the height of the rib being lowest at the opposite ends. Further, the resin molded article may be formed in a rectangular cylinder shape having a bottom as shown in FIG. 9.

It should be noted that although the resin molded articles according to the embodiments of the present invention have been described as those used in the vehicle, use of the resin part (resin molded article) is not limited to the vehicle. In other words, as long as the advantageous effects of the present invention are achieved, the present invention is not limited to the embodiments.

What is claimed is:

1. A resin molded article comprising:
a plate portion, which defines one face of a main body formed in a rectangular cylinder shape, the main body having an opening, at least, at one end of the main body, the plate portion having a substantially rectangular plate shape; and
at least one rib which is integrally raised from the plate portion,
wherein when sides of the plate portion, which are adjacent to the opening, are taken as opening sides, each of the at least one rib is formed along at least one of the opening sides such that each of the at least one rib comprises at least an area over a center of the opening side, and
a height of each of the at least one rib is set such that the rib is lowest at opposite ends of the rib.

2. The resin molded article according to claim 1, wherein when a value obtained by dividing a difference between the height of the rib at the opposite ends and the height of the rib at the center of the open side by a length between the opposite ends of the rib is taken as a curvature, the curvature is 0.01 or more.

3. The resin molded article according to claim 1, wherein an upper end of the rib has a generally curved arch shape.

4. The resin molded article according to claim 1 further comprising an extending portion extending from an upper end of the rib in a direction substantially perpendicular to the rib.

5. A resin molded article comprising:
a main body formed in a rectangular cylinder shape and having an opening, at least, at one end of the main body, the main body being defined by four plate portions, each of the plate portions being a substantially rectangular plate;
two ribs formed on two of the four plate portions facing each other, respectively, such that each of the two ribs is integrally raised from one side of the plate portion concerned, the one side being an opening side that extends adjacent to the opening of the main body; and
second ribs which are integrally raised from the remaining two of the four plate portions such that the second ribs connect the two ribs to each other,
each of the two ribs being longer than each of the second ribs, and being formed in an arch shape such that the rib is highest at a center of the opening side and lowest at opposite ends of the rib, and
a value obtained by dividing a difference between a highest height at a site where a height of the rib is highest and a lowest height at another site where the height of the rib is lowest by a length of the rib being taken as a curvature, and the curvature being set to be 0.01 or more.

6. The resin molded article according to claim 5 further comprising two extending portions extending from the two ribs, respectively, such that each of the extending portions extends from an upper end of the rib concerned, in a direction substantially perpendicular to the rib.

7. A resin molded article comprising:
a plate portion formed in a substantially rectangular plate shape, and
a rib which is integrally raised from the plate portion,
the plate portion body having a pair of long sides facing each other, and a pair of short sides facing each other, the short sides being shorter than the long sides,
the rib being formed along at least one of the long sides such that the rib comprises at least an area over a center of the long side, and
a height of the rib being set such that the rib is lowest at opposite ends of the rib.

8. The resin molded article according to claim 7, wherein an upper end of the rib has a generally curved arch shape.

9. The resin molded article according to claim 7 further comprising an extending portion extending from an upper end of the rib in a direction substantially perpendicular to the rib.
